(19) United States
(12) Patent Application Publication
(10) Pub. No.: US 2026/0321165 A1
(43) Pub. Date: Oct. 15, 2026

(54) SELF-SUPPORTED SCREEN ASSEMBLY

(71) Applicant: JKL CORPORATION, SEOUL (KR)

(72) Inventor: Jeh Kun LAH, Seoul (KR)

(21) Appl. No.: 19/109,320

(22) PCT Filed: Sep. 1, 2023
(86) PCT No.: PCT/KR2023/013061

§ 371 Date: Mar. 6, 2025

(30) Foreign Application Priority Data
Sep. 7, 2022 (KR) 10-2022-0113196

(51) Int. Cl. G09F 7/18

(52) U.S. Cl. CPC G09F 7/18; G09F 2007/1856

(57) ABSTRACT

The present disclosure relates to a self-supported screen assembly and may provide the self-supported screen assembly including: a plurality of front poles and a plurality of rear poles symmetrically extending in the front and rear direction, respectively, to form an X-shaped frame from a connector at the center thereof; a front screen member having corners coupled to end portions of the plurality of front poles, respectively; a rear screen member having corners coupled to end portions of the plurality of rear poles, respectively; and a plurality of connection members for connecting each end portion of the plurality of front poles and each end portion of the plurality of rear poles symmetrically corresponding thereto.

### CROSS-REFERENCE TO RELATED APPLICATION

This application claims the benefit of KR Patent Application No. 10-2022-0113196, filed on Sep. 7, 2022, which is hereby incorporated by reference herein in its entirety.

### TECHNICAL FIELD

The present disclosure relates to a self-supported screen assembly, and more specifically, to a screen assembly that is capable of standing independently on the ground only through the assembly structure of a plurality of poles and a screen.

### BACKGROUND ART

A stand structure is arranged upright at the front of an event venue or exhibition, being used as an advertising means on which phrases, shapes, photographs, etc. are held so that passing pedestrians (viewers) can easily grasp the event details, product information, and the like. Typically, fabrics, resin sheets, or other materials containing advertisements such as photographs and text are coupled to supports on the base.

A typical stand structure is configured to be arranged at a desired location by filling the base with sand, water, or the like, and the support frame for coupling the banner is adjustable in height, allowing for accommodating banners of various sizes.

However, when assembling the conventional stand structure, separate assembly tools are required to fasten each coupling part, and it is necessary to have a certain weight to prevent it from easily falling over due to external forces such as wind, making it difficult to move and handle.

For example, the stand structure described in Korean Patent No. 10-1414279 forms the stand structure through a plurality of poles and a central assembly. However, since the central assembly acts as the center of gravity, with the support poles bearing the entire weight, the structure is prone to having the center of gravity shift easily under certain external forces.

Therefore, the stand structure described in Korean Patent No. 10-1414279 is suitable for indoor use, but it is difficult to use in outdoors where external forces such as wind may act.

### SUMMARY

Therefore, to solve the problems of the aforementioned technologies, an embodiment of the present disclosure aims to provide a screen assembly that is capable of stably standing independently on the ground only through the assembly structure of a plurality of poles and a screen.

To achieve the aforementioned technical objects, there is provided a self-supported screen assembly, according to at least some embodiments of the present disclosure. The self-supported screen assembly may include: a plurality of front poles and a plurality of rear poles each extending symmetrically in front and rear directions from a central connector to form an X-shaped frame; a front screen member having corner portions respectively coupled to end portions of the plurality of front poles; a rear screen member having corner portions respectively coupled to end portions of the plurality of rear poles; and a plurality of connection members connecting each end portion of the plurality of front poles to each end portion of the plurality of rear poles symmetrically corresponding thereto.

In addition, the front screen member and the rear screen member may be each arranged vertically relative to the ground.

In addition, the plurality of front poles and the plurality of rear poles may be fitted and coupled into a plurality of pole insertion holes formed in the connector.

In addition, each corner portion of the front screen member and the rear screen member may have an eyelet formed therein, and a protrusion formed on each end portion of the pole may be inserted into each of the eyelets.

In addition, each of the plurality of connection members may be adjustable in length in the front and rear directions, each of the plurality of connection members may include a front connection member and a rear connection member, and the front connection member and the rear connection member may be able to be coupled and uncoupled with a buckle.

In addition, the self-supported screen assembly of the present disclosure may further include an additional connection member connecting a point on a side edge of the front screen member and a point on a side edge of the rear screen member at a position corresponding thereto, in which the additional connection member may include an additional front connection member and an additional rear connection member that are able to be coupled and uncoupled with the buckle, and the additional connection member may be fixed to the ground using a string and a fixing member.

In addition, the central connector may be formed as a single unit.

In addition, the central connector may be separable into a front connector, into which the plurality of front poles are fitted and coupled, and a rear connector, into which the plurality of rear poles are fitted and coupled.

In addition, the front connector may include one of a male coupling portion or a female coupling portion, and the rear connector may include the other of the male coupling portion or the female coupling portion, and the male coupling portion and the female coupling portion may be fitted together and coupled.

In addition, the front connector and the rear connector may each further include a central coupling hole at a position opposite to the male coupling portion or the female coupling portion, and the front connector and the rear connector may be supported and connected to each other through a central bar between the central coupling hole of the front connector and the central coupling hole of the rear connector.

In addition, the central coupling hole and the central bar may be threadedly coupled.

Through the self-supported screen assembly of the present disclosure per at least some embodiments, since the screen members contact the ground surface, it is possible to provide stability for the independent standing of the screen assembly.

Through the self-supported screen assembly of the present disclosure per at least some embodiments, the rigidity of the entire screen assembly can be maintained with only the structure of the screen and poles, and the tension of the screen surface can be adjusted depending on the length of the connection member.

### DESCRIPTION OF DRAWINGS

FIG. 1 schematically illustrates a perspective view of a self-supported screen assembly according to an embodiment of the present disclosure.

FIG. 2 schematically illustrates a side view of the self-supported screen assembly according to an embodiment of the present disclosure.

FIG. 3 schematically illustrates the coupling of a plurality of front poles and a plurality of rear poles from a central connector to form the frame of the self-supported screen assembly according to an embodiment of the present disclosure.

FIG. 4 schematically illustrates the connection of the end portions of the plurality of front poles and the end portions of the plurality of rear poles by a connection member in the self-supported screen assembly according to an embodiment of the present disclosure.

FIG. 5 schematically illustrates the separation of the central connector into a front connector and a rear connector, which are fitted together and coupled, in the self-supported screen assembly according to an embodiment of the present disclosure.

FIG. 6 schematically illustrates the coupling of the front connector and rear connector through a central bar in the self-supported screen assembly according to an embodiment of the present disclosure.

FIG. 7 schematically illustrates the central connector being separated into the front connector and the rear connector, supported and connected to each other through the central bar in the self-supported screen assembly according to an embodiment of the present disclosure.

FIGS. 8A and 8B schematically illustrate embodiments in which the width of the entire screen assembly is adjusted according to a coupling method of the front connector and rear connector in the self-supported screen assembly according to an embodiment of the present disclosure.

FIG. 9 schematically illustrates the coupling of a screen member to the end portion of a plurality of poles, respectively and the separation of the connection member into a front connection member and a rear connection member, which are coupled together with a buckle, in the self-supported screen assembly according to an embodiment of the present disclosure.

FIGS. 10A and 10B are conceptual views schematically illustrating the application of the self-supported screen assemblies according to an embodiment of the present disclosure as a golf screen.

FIG. 11 schematically illustrates the arrangement of an additional support structure in the self-supported screen assembly, according to another embodiment of the present disclosure.

### DETAILED DESCRIPTION

Hereinafter, a self-supported screen assembly according to an embodiment of the present disclosure will be described with reference to the accompanying drawings.

Prior to the description, unless explicitly described to the contrary, the word “comprise” or “include” and variations, such as “comprises”, “comprising”, “includes” or “including”, will be understood to imply the inclusion of stated constituent elements, not the exclusion of any other constituent elements.

In addition, in the various embodiments, the constituent elements having the same constitution will be described using the same reference numerals, typically in an embodiment, and only different constituent elements will be described in other embodiments.

Further, while the embodiments of the present disclosure have been described with reference to the accompanying drawings, they are described for illustrative purposes only and are not intended to limit the technical spirit of the present disclosure and the constitution and application thereof.

With reference to the accompanying drawings, a self-supported screen assembly 1 of the present disclosure will be described in detail through a specific embodiment.

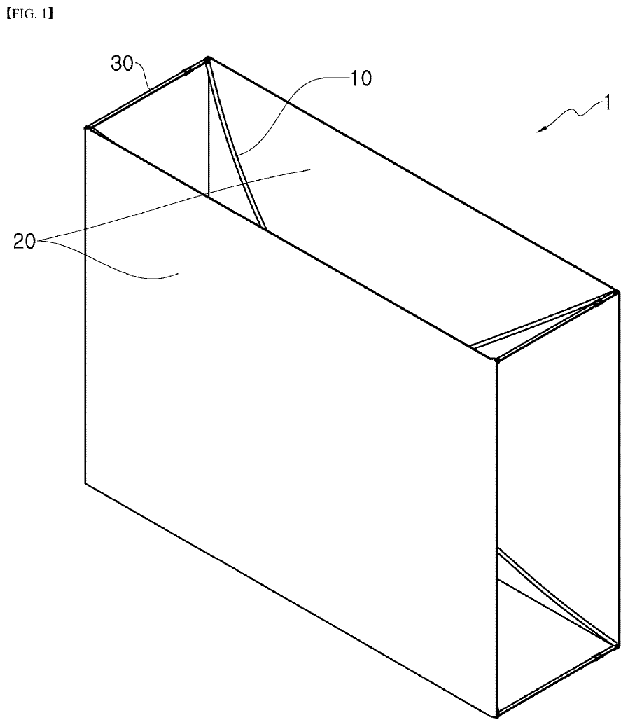

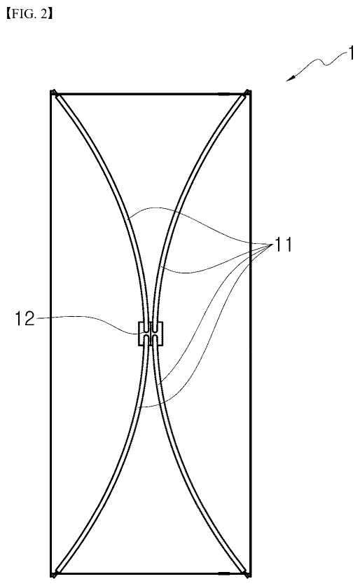

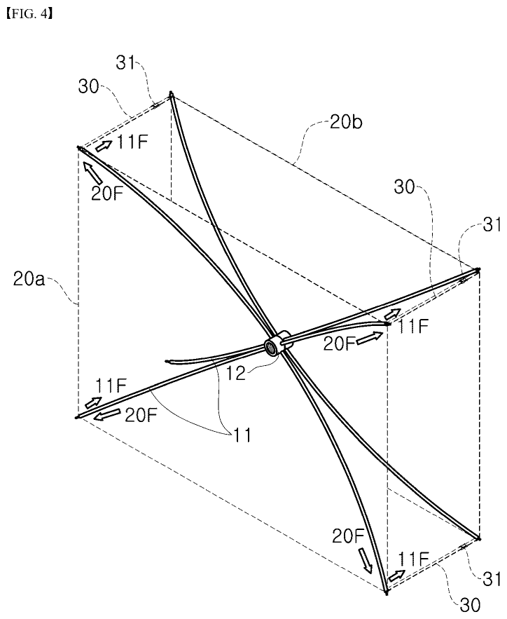

FIG. 1 schematically illustrates a perspective view of the self-supported screen assembly 1 according to an embodiment of the present disclosure, FIG. 2 schematically illustrates a side view of the self-supported screen assembly 1 according to an embodiment of the present disclosure, and FIG. 4 schematically illustrates the connection of the end portions of a plurality of front poles 11a and the end portions of a plurality of rear poles 11b with a connection member 30 in the self-supported screen assembly 1 according to an embodiment of the present disclosure.

As illustrated in FIG. 1, FIG. 2, and FIG. 4, the self-supported screen assembly 1 according to an embodiment of the present disclosure has a plurality of front poles 11a and a plurality of rear poles 11b, which symmetrically extend in the front and rear directions from a central connector 12, forming an X-shaped frame that is arranged symmetrically in the front and rear directions.

In addition, the corner portions of the front screen 20a are coupled to the end portions of each of the plurality of front poles 11a, and the corner portions of the rear screen 20b are coupled to the end portions of each of the plurality of rear poles 11b.

In addition, a plurality of connection members 30 connect the end portions of the plurality of front poles 11a with the end portions of the plurality of rear poles 11b, which correspond symmetrically.

Therefore, by simply assembling the corner portions of front and rear screen members 20a and 20b, which are respectively coupled to the end portions of the plurality of front poles 11a and rear poles 11b, with the connection member 30, the self-supported screen assembly 1 may be easily installed.

In addition, since each of the plurality of front and rear poles 11a and 11b of the self-supported screen assembly 1 according to an embodiment of the present disclosure is curved in an arc shape in the embodiment of the present disclosure, when the screen members 20a and 20b are coupled, the plurality of front and rear poles 11a and 11b, through their elastic force 11F attempting to restore to the inside of the screen assembly 1, may induce a tension 20F that pulls the screen members 20a and 20b towards each corner portion. As a result, the screen members 20a and 20b may be kept taut.

Therefore, the front screen member 20a and rear screen member 20b may each be arranged vertically relative to the ground. When the self-supported screen assembly 1 according to an embodiment of the present disclosure is installed, it may form a shape of approximately a rectangular parallelepiped, allowing the screen assembly 1 to be stably arranged.

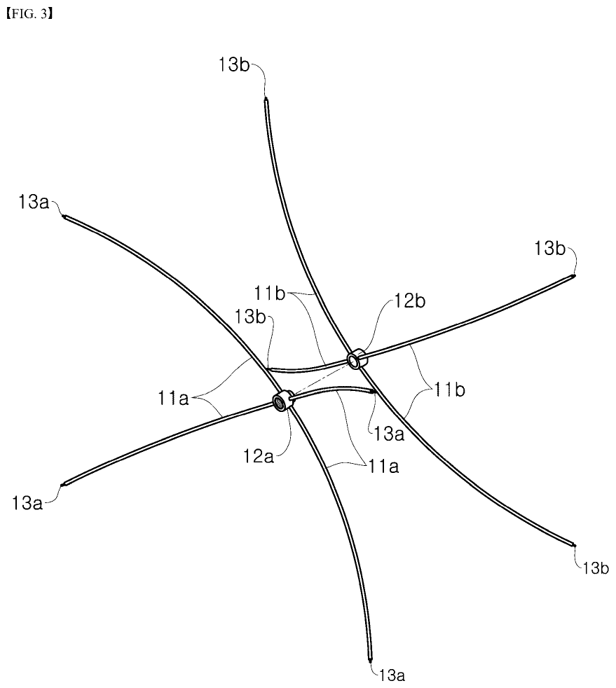

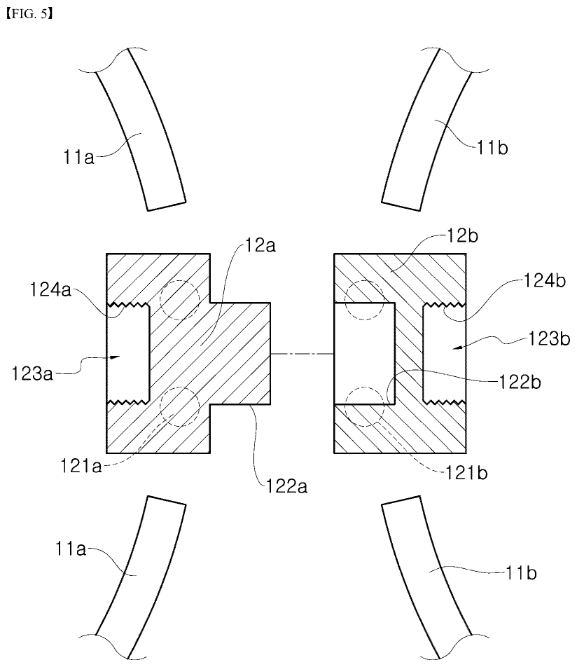

FIG. 3 schematically illustrates the coupling of the plurality of front poles 11a and the plurality of rear poles 11b from the central connector 12 to form the frame of the self-supported screen assembly 1 according to an embodiment of the present disclosure, and FIG. 5 schematically illustrates the separation of the central connector 12 into a front connector 12a and a rear connector 12b, which are coupled together in the self-supported screen assembly 1 according to an embodiment of the present disclosure.

As illustrated in FIG. 3 and FIG. 5, the plurality of front poles 11a and the plurality of rear poles 11b of the self-supported screen assembly 1 according to an embodiment of the present disclosure may be connected by being fitted and coupled into a plurality of pole insertion holes 121a and 121b formed in the central connector 12.

Meanwhile, the central connector 12 may be formed as a single unit, but it is also possible to separate it into a front connector 12a for fitting and coupling with the plurality of front poles 11a and a rear connector 12b for fitting and coupling with the plurality of rear poles 11b, and then assemble the front connector 12a and rear connector 12b together to form the central connector 12.

For example, as illustrated in FIG. 5, the front connector 12a of the self-supported screen assembly 1 according to an embodiment of the present disclosure may have a male coupling portion 122a, and the rear connector 12b may have a female coupling portion 122b, allowing these male and female coupling portions 122a and 122b to be fitted together and coupled.

In addition, after assembling the entire self-supported screen assembly 1 by fitting and coupling the male coupling portion 122a and the female coupling portion 122b together, a force is applied that pulls the front and rear screen members 20a and 20b in the inward direction due to the connection member 30, which will be described below. As a result, the coupled male coupling portion 122a and female coupling portion 122b are prevented from separating.

Therefore, there is an advantage per an embodiment in that the front and rear portions of the screen assembly 1 may be easily assembled independently, and the entire screen assembly 1 may be assembled simply by fitting the front connector 12a and rear connector 12b together.

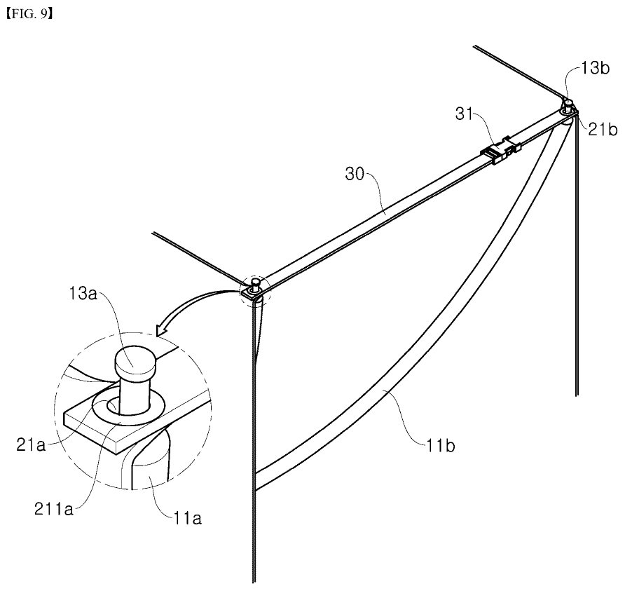

FIG. 4 schematically illustrates the connection of the end portions of the plurality of front poles 11a and the end portions of the plurality of rear poles 11b with the connection member in the self-supported screen assembly 1 according to an embodiment of the present disclosure, and FIG. 9 schematically illustrates the coupling of the front and rear screen members 20a and 20b to the end portions of the front and rear poles 11a and 11b, respectively, in the self-supported screen assembly according to an embodiment of the present disclosure.

As illustrated in FIG. 4 and FIG. 9, the connection members 30 of the self-supported screen assembly 1 according to an embodiment of the present disclosure are adjustable in length in the front and rear directions. Specifically, the length of the connection member 30 may be adjusted to maintain the tension 20F at each corner portion of the screen member 20, depending on the elastic force 11F of the front and rear poles 11a and 11b.

Therefore, as the end portions of the front and rear poles are connected by the connection member 30, an additional force that respectively pushes the front and rear poles toward the screen member 20 may be applied, thereby allowing the screen member 20 to be kept even more taut.

In addition, as illustrated in FIG. 9, by separating each connection member 30 into a front connection member and a rear connection member, and coupling and uncoupling the front and rear connection members with a coupling member such as a buckle 31, as described above, the front and rear portions of the screen assembly 1 may be assembled independently from each other. This provides the advantage according to an embodiment of easily assembling the entire screen assembly 1 simply by coupling the front connection member and rear connection member together.

Meanwhile, as illustrated in FIG. 9, by forming eyelets 211a at each corner portion of the front and rear screen members 20a and 20b, and inserting protrusions 13a formed at the end portions of poles into holes 21a of these eyelets 211a to couple the poles 11 and the screen members 20, damage to the screen members 20a and 20b due to repeated installation and disassembly may be prevented.

In addition, as illustrated in FIG. 9, since the protrusion 13a is formed with a step such that the diameter of the end portion of the protrusion is larger than the diameter of the inner side of the protrusion, it may prevent the eyelet 211a from unintentionally detaching from the protrusion 13a.

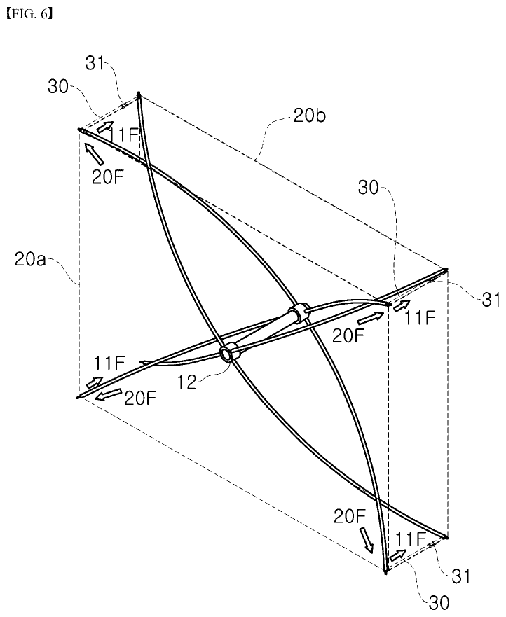

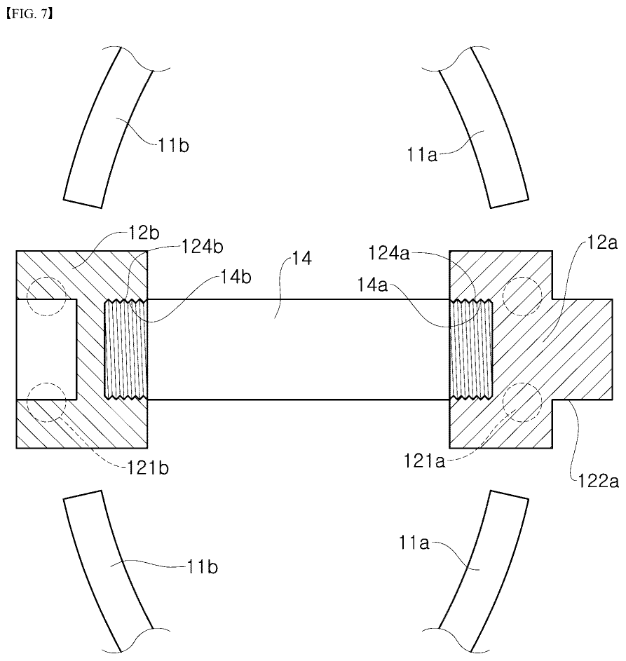

FIG. 6 schematically illustrates the coupling of the front connector 12a and rear connector 12b of the self-supported screen assembly 1 according to an embodiment of the present disclosure through a central bar 14, and FIG. 7 schematically illustrates the separation of the central connector 12 into the front connector 12a and the rear connector 12b, which are supported and connected to each other through the central bar 14 in the self-supported screen assembly 1 according to an embodiment of the present disclosure.

As illustrated in FIG. 6 and FIG. 7, by swapping the positions of the front connector 12a and rear connector 12b from the embodiments illustrated in FIG. 4 and FIG. 5, the width of the self-supported screen assembly 1 may be further reduced.

Specifically, the front connector 12a and rear connector 12b may each further include a central coupling hole in a position opposite to the male coupling portion 122a or female coupling portion 122b formed on each. The central bar 14 may be arranged between the central coupling hole of the front connector 12a and the central coupling hole of the rear connector 12b, allowing the front connector 12a and rear connector 12b to be connected and supported by each other.

In addition, both ends of the central bar 14 are each formed with threaded portions 14a and 14b, and the inner surfaces of the central coupling hole in the front connector 12a and the central coupling hole in the rear connector 12b are also each formed with threaded portions 124a and 124b. As a result, the central coupling holes of the front connector 12a and rear connector 12b may be threadedly coupled with the central bar 14, allowing the user to easily couple the front connector 12a and rear connector 12b with the central bar 14.

That is, in order to further adjust the width of the screen assembly 1, the front connector 12a and rear connector 12b illustrated in FIG. 4 and FIG. 7 need to be positioned closer to the screen side. In this case, each of the plurality of front poles 11a and plurality of rear poles 11b needs to maintain their already bent state in order to maintain the tension of the screens 20a and 20b.

Therefore, since the plurality of front poles 11a and plurality of rear poles 11b connected to the front connector 12a and rear connector 12b have forces that tend to expand in opposite directions, it is necessary per an embodiment to connect and secure the space between the front connector 12a and rear connector 12b with the central bar 14.

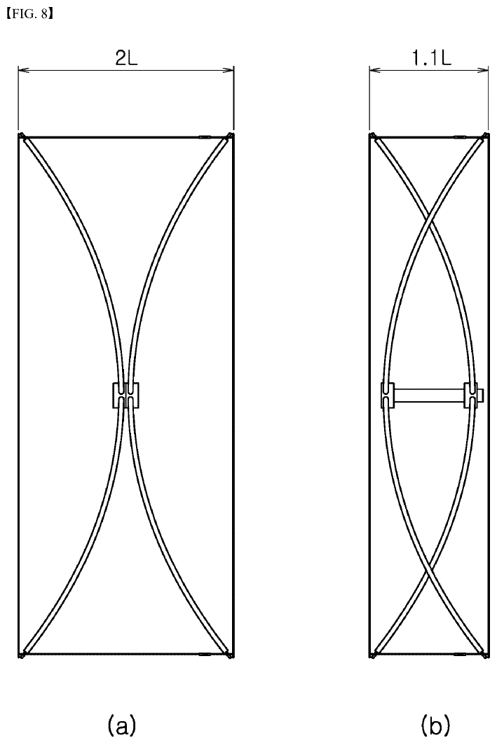

FIGS. 8A and 8B schematically illustrate embodiments in which the width of the entire screen assembly 1 is adjusted according to a coupling method of the front connector 12a and rear connector 12b in the self-supported screen assembly 1 according to an embodiment of the present disclosure.

Specifically, as illustrated in FIG. 8B, in the embodiment where the front connector 12a and rear connector 12b are connected by the central bar 14, the front connector 12a and rear connector 12b may be moved as far as possible in the screen direction, thereby significantly reducing the width of the screen assembly 1.

For example, as illustrated in FIG. 8A, when the central connector 12 is formed as a single unit, or when the front connector 12a and rear connector 12b are fitted and coupled using the male coupling portion 122a and female coupling portion 122b, the width of the screen assembly 1 is set to 2L. In contrast, as illustrated in FIG. 8B, in the embodiment where the front connector 12a and rear connector 12b are connected by the central bar 14, the width of the screen assembly 1 may be reduced to approximately 1.1L.

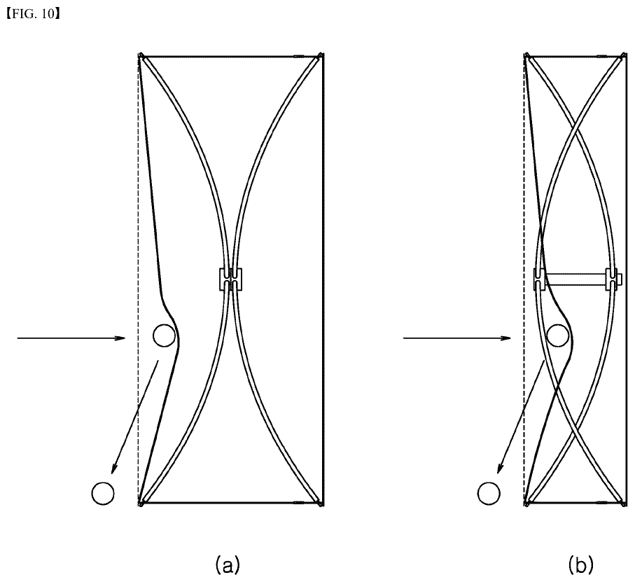

FIGS. 10A and 10B are conceptual views schematically illustrating the application of the self-supported screen assemblies 1 according to the embodiments of the present disclosure as golf screens.

As in the explanation of FIG. 9 described above, since there is a movable clearance space at the coupling position between the hole 21a of the eyelet 211a and the protrusion 13a of the end portion of the pole, as illustrated in FIG. 10, when an impact, such as from a golf ball, is applied, the impact may be alleviated through the aforementioned clearance space.

Specifically, as illustrated in FIGS. 10A and 10B, even if an impact is applied to the screen member 20, the elastic force of the pole 11 itself is used to absorb the impact. At the same time, when the connection member 30 made of a material such as webbing is used, the screen member 20 may move in the front and rear directions. As a result, the golf ball does not bounce in the opposite direction but falls downward.

Although not specifically illustrated in the drawings, as described above, due to the tension pulling each corner portion of the screen member 20 outward, no wrinkles or other deformations are formed on the screen member. Therefore, for example, the screen assembly 1 according to the embodiments of the present disclosure may also be used as an outdoor screen for use in outdoor environments.

In addition, when multiple screen assemblies 1 in the form of rectangular parallelepipeds are arranged using a simple installation method, it is possible to expand the size of the screen member 20 as needed, allowing it to be used as a large screen for large outdoor stages.

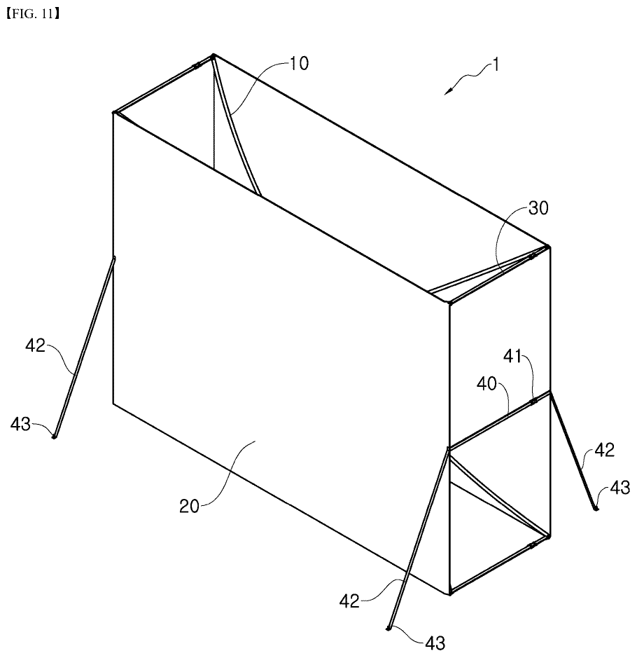

FIG. 11 schematically illustrates the arrangement of an additional support structure in the self-supported screen assembly, according to another embodiment of the present disclosure.

As illustrated in FIG. 11, an additional support structure may be arranged on the screen assembly 1 to further secure the self-supporting ability of the screen assembly 1.

Specifically, by arranging an additional connection member 40 at a point on the side edge of the screen member 20, similar to the aforementioned connection member 30, the front and rear screen members 20a and 20b may be further connected. When this additional connection member 40 is fixed to the ground using a string 42 and a fixing member 43 (e.g., a peg), additional self-supporting stability for the screen assembly 1 may be ensured in outdoor environments where wind and other factors have a greater impact.

In addition, as illustrated in FIG. 11, the additional connection member 40 may also be separated into an additional front connection member and an additional rear connection member, and these may be coupled and uncoupled using an additional buckle 41.

A person skilled in the art may understand that the present disclosure may be carried out in other specific forms with reference to the above-mentioned descriptions without changing the technical spirit or the essential characteristics of the present disclosure.

Accordingly, it is to be understood that the embodiments described above are illustrative in all respects and are not intended to limit the present disclosure to the embodiments, and the scope of the present disclosure is indicated by the patent claims which are hereinafter recited rather than by the foregoing detailed description, and the meaning and scope of the patent claims and all modifications or variations derived from the equivalent concepts should be interpreted to be included within the scope of the present disclosure.

As used herein, the terms “general,” “generally,” and “approximately” are intended to account for the inherent degree of variance and imprecision that is often attributed to, and often accompanies, any design and manufacturing process, including engineering tolerances, and without deviation from the relevant functionality and intended outcome, such that mathematical precision and exactitude is not implied and, in some instances, is not possible.

All the features and advantages, including structural details, spatial arrangements and method steps, which follow from the claims, the description and the drawing can be fundamental to the invention both on their own and in different combinations. It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation.

List of reference numerals

| | |
|---|---|
| 1 Self-supported screen assembly | 10 Plurality of poles |
| 11a Plurality of front poles | 11b Plurality of rear poles |
| 12 Connector | 12a Front connector |
| 12b Rear connector | 13a Protrusion of end portion of pole |
| 14 Central bar | 14a Threaded portion in front |
| | connector direction |
| 14b Threaded portion in rear | 121a Front pole insertion hole |
| connector direction | |
| 121b Rear pole insertion hole | 122a Male coupling portion |
| 122b Female coupling portion | 124a Front connector threaded |
| | portion |
| 124b Rear connector threaded | 20 Screen member |
| portion | |
| 20a Front screen member | 20b Rear screen member |
| 21a Eyelet hole | 211a Eyelet |
| 30 Connection member | 31 Buckle |
| 40 Additional connection member | 41 Additional buckle |
| 42 String | 43 Fixing member |

1. A self-supported screen assembly, comprising:
a plurality of front poles and a plurality of rear poles each extending symmetrically in front and rear directions from a central connector to form an X-shaped frame;
a front screen member having corner portions respectively coupled to end portions of the plurality of front poles;
a rear screen member having corner portions respectively coupled to end portions of the plurality of rear poles; and
a plurality of connection members connecting each end portion of the plurality of front poles to each end portion of the plurality of rear poles symmetrically corresponding thereto.

2. The self-supported screen assembly of claim 1, wherein the front screen member and the rear screen member are each arranged vertically relative to the ground.

3. The self-supported screen assembly of claim 1, wherein the plurality of front poles and the plurality of rear poles are fitted and coupled into a plurality of pole insertion holes formed in the connector.

4. The self-supported screen assembly of claim 1, wherein each corner portion of the front screen member and the rear screen member has an eyelet formed therein, and a protrusion formed on each end portion of the pole is inserted into each of the eyelets.

5. The self-supported screen assembly of claim 1, wherein each of the plurality of connection members is adjustable in length in the front and rear directions.

6. The self-supported screen assembly of claim 5, wherein each of the plurality of connection members includes a front connection member and a rear connection member, and the front connection member and the rear connection member are able to be coupled and uncoupled with a buckle.

7. The self-supported screen assembly of claim 6, further comprising:
an additional connection member connecting a point on a side edge of the front screen member and a point on a side edge of the rear screen member at a position corresponding thereto,
wherein the additional connection member includes an additional front connection member and an additional rear connection member that are able to be coupled and uncoupled with the buckle, and the additional connection member is fixed to the ground using a string and a fixing member.

8. The self-supported screen assembly of claim 1, wherein the central connector is formed as a single unit.

9. The self-supported screen assembly of claim 1, wherein the central connector is separable into a front connector, into which the plurality of front poles are fitted and coupled, and a rear connector, into which the plurality of rear poles are fitted and coupled.

10. The screen assembly of claim 9, wherein the front connector includes one of a male coupling portion or a female coupling portion, and the rear connector includes the other of the male coupling portion or the female coupling portion, and the male coupling portion and the female coupling portion are fitted together and coupled.

11. The screen assembly of claim 10, wherein the front connector and the rear connector each further include a central coupling hole at a position opposite to the male coupling portion or the female coupling portion, and the front connector and the rear connector are supported and connected to each other through a central bar between the central coupling hole of the front connector and the central coupling hole of the rear connector.

12. The screen assembly of claim 11, wherein the central coupling hole and the central bar are threadedly coupled.
